(19) United States
(12) Patent Application Publication
(10) Pub. No.: US 2013/0316040 A1
(43) Pub. Date: Nov. 28, 2013

(54) Mold-Tool System Includes One-Piece Manifold Assembly having Each Inlet in Fluid Communication with Outlets

(71) Applicants: Sean Arthur Chase, Essex Junction, VT (US); Patrice Fabien Dezon-Gaillard, Jericho, VT (US); Darrin Albert Macleod, Jeffersonville, VT (US)

(72) Inventors: Sean Arthur Chase, Essex Junction, VT (US); Patrice Fabien Dezon-Gaillard, Jericho, VT (US); Darrin Albert Macleod, Jeffersonville, VT (US)

(73) Assignee: Husky Injection Molding Systems Ltd., Bolton, ON (CA)

(21) Appl. No.: 13/981,732

(22) PCT Filed: Jan. 25, 2012
(86) PCT No.: PCT/US12/22456

§ 371 Date: Jul. 25, 2013

Related U.S. Application Data
(60) Provisional application No. 61/444,150, filed on Feb. 18, 2011.
(60) Provisional application No. 61/590,083, filed on Jan. 24, 2012.

(51) Int. Cl. B29C 45/17

(52) U.S. Cl. CPC B29C 45/1775
USPC 425/573

(57) ABSTRACT

A mold-tool system (100), having a one-piece manifold assembly (102) is provided. The one-piece manifold assembly (102) has: a plurality of inlets (104); and a plurality of outlets (106) spaced apart from the plurality of inlets (104). A plurality of melt channels extend between the plurality of inlets and the plurality of outlets, and each melt channel extends between a single inlet and at least two outlets such that each inlet (104) is in fluid communication with at least two outlets (106).

### TECHNICAL FIELD

An aspect generally relates to a mold-tool system including: a one-piece manifold assembly with each inlet in fluid communication with a respective at least two outlets.

### BACKGROUND

United States Patent Publication Number 2007/0077328 discloses an injection molding apparatus having a manifold and several manifold melt channels communicating with several hot runner nozzles includes a melt redistribution element. The melt redistribution element is placed at specific locations along the melt channels to balance the uneven shear stress profile accumulated during the flow of a melt along the manifold channels. The melt redistribution element has an unobstructed central melt bore having at its inlet a narrowing tapered channel portion. The melt redistribution element also includes a helical melt pathway portion that surrounds the central melt bore. The incoming melt is first subjected to a pressure increase by the tapered portion that causes the melt to flow at a higher velocity through the central melt bore. The outer portion of the melt is forced to flow along the helical path and thus it changes direction multiple times and partially mixes with the melt flowing through the central melt bore.

U.S. Pat. No. 5,989,003 discloses an apparatus for molding consecutive streams of differently and homogeneously colored resin in a single mold. The apparatus is used to practice a method including supplying molten resin to a selected one of a plurality of resin passages, injecting colorant selected from a plurality of different colorants into the resin passage, mixing the molten resin and colorant in a mixing element disposed in the resin passage to form a mixture of selectively colored resin, injecting the mixture into the single mold to form a part from the selectively colored resin, and repeating the process by selecting a different resin passage and a different colorant.

United States Patent Publication Number 2007/0119574 discloses a cooling unit for cooling in particular power semiconductors contains a distributor for guiding liquid across a surface to be cooled. The distributor comprises an inlet manifold and outlet manifold, whereby the inlet and outlet manifolds are connected through a flow cell, which has a main flow channel. The main channel is formed as a meandering sequence of channel segments. It has been found, that the transfer of heat by the liquid in the main flow channel can be improved by introducing a bypass flow channel, which allows the flow of liquid from the cell inlet to the cell outlet, wherein the bypass flow channel interconnects the channel segments of the main flow channel.

U.S. Pat. No. 3,940,224 discloses a plastic injection blow molding manifold that has progressively smaller passageways defined at the mating surfaces between its two primary members. The circular cross sectional inlet area is reduced by one-half in a first cross passageway, and then further reduced in two additional cross passageways in an eight nozzle version. All of these cross passageways are defined at said mating surfaces, and the respective ends of such additional cross passageways communicate with paired outlets, each of which outlets has an associated nozzle and coaxially arranged heating element.

U.S. Pat. No. 4,761,343 discloses a manifold system for a multi-cavity injection molding system. The manifold system has one elongated bridging manifold, which extends transversely across a number of spaced elongated support manifolds. Each of the support manifolds, in turn, extends across a number of heated probes or nozzles, each of which leads to a gate to a cavity. The bridging manifold has a portion of the hot runner passage extending through it from a single inlet to receive melt from the molding machine to a number of spaced outlets. Each of the support manifolds also has an inlet, which is in alignment with one of the outlets from the bridging manifold and a number of spaced outlets. Each of the outlets of the support manifolds is in alignment with an inlet to one of the probes or nozzles. Each of the manifolds has two way junctions at which a larger diameter portion of the hot runner passage joins two smaller diameter downstream portions. In the bridging manifold, the hot runner passage extends along the same plane as the inlet and outlets, whereas in the support manifold the portion connecting the junctions extends in a transverse plane.

United States Patent Publication Number 2004/0091568 discloses a hot runner manifold for a multi-cavity injection molding system. The manifold is formed in a manifold block and an insert. This insert may be a round bar which outward shape is grooved with flow channel. Or this insert may be combined by a set of a grooved round bar together with matched grooved pipes. This insert will be inserted into the bore of manifold block. This grooved insert work as a flow channel inside the manifold. Compared to the traditional manifold, first this invention can easily help produce a balance-flow manifold. That will shorten the delivery time. Second, this invention can help produce an inexpensive cost of a balance-flow manifold. Third, this invention provides an easier structure to make multiple-drops (such as 12, 16, 32, 64, 256 drops) in an elongated direction with balance flow. Fourth, this invention can provide a manifold structure to help the flow channel of insert to be easily taken off for cleaning. Finally, this invention can provide a very good temperature-balance manifold in order to help molding nice quality plastic for each drop. Because the insert can be made by a good heat-conduct material and then to get an equalized temperature in each drop inside the manifold.

U.S. Pat. No. 5,007,821 discloses an injection molding heated manifold having a melt passage with a longitudinal portion to convey melt from a molding machine to a number of different nozzles. The steel manifold has a pair of cooling bores extending parallel to and equally spaced on opposite sides of the longitudinal portion of the melt channel. A cooling fluid, such as air, flows through the cooling bores to quickly cool the manifold after the system is shut down to minimize deterioration of the melt in the melt channel. The air flows helically around spiral vanes which are mounted in the cooling bores to avoid temperature stratification along the melt passage.

U.S. Pat. No. 7,320,589 discloses a method and apparatus for rotating a cross-sectional asymmetrical condition of a laminar flowing material in a hot runner system for supplying a laminar flowing material. The hot runner system has (i) an upstream melt passage, (ii) a pair of intermediary melt passages downstream from the upstream melt passage, and (iii) for at least one intermediary melt passage, an associated pair of downstream melt passages downstream from the at least one intermediary melt passage. The cross-sectional asymmetrical condition of a laminar flowing material is rotated by providing a bending path for orienting at least one path outlet relative to a path inlet to rotate the cross-sectional asymmetrical condition of the laminar flowing material such that the cross-sectional asymmetrical condition is substantially equally divided between the two downstream portions.

U.S. Pat. No. 5,536,164 discloses a manifold assembly for supplying plastic material from a plastic source to a mold assembly in an injection molding machine. It includes a flexible manifold having an interior conduit connected between the plastic source and the mold assembly. The flexible manifold is configured to define an input connector, a first curved segment attached to the input connector, a second curved segment, an output connector attaching the second curved segment to the mold assembly, and an intermediary segment connecting the first and second curved segments. This provides the flexible manifold with a generally S-shaped configuration that flexes with temperature changes to maintain a substantially constant positioning between the input connector and the output connector, preventing thermally induced movement of the mold assembly with respect to the input connector as heated plastic is injected through the conduit.

### SUMMARY

According to one aspect, a mold-tool system is provided. The one-piece manifold assembly has: a plurality of inlets, and a plurality of outlets spaced apart from the plurality of inlets. A plurality of melt channels extend between the plurality of inlets and the plurality of outlets, where each melt channel extends between a single inlet and at least two outlets such that each inlet is in fluid communication with at least two outlets.

According to another aspect, a one-piece manifold assembly for a mold-tool system is provided. The manifold assembly includes a plurality of inlets, a plurality of outlets, where the ratio of outlets to inlets is at least 2:1, and a plurality of melt channels. Each melt channel extends between a single inlet and at least two outlets, and each outlet is connected to the melt channel by an associated melt channel section, such that each inlet is in fluid communication with at least a first melt channel section associated with one outlet and a second melt channel selection associated with another outlet. The first melt channel section has a first length and the second melt channel section has a second length, where the first length is substantially equal to the second length.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

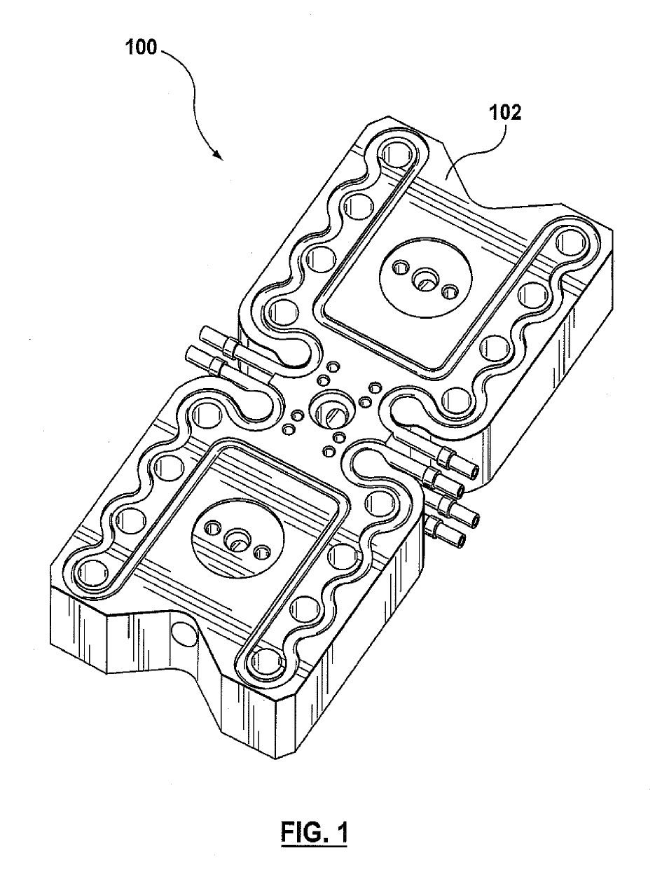

FIG. 1 is a schematic perspective view of a mold-tool system according to one embodiment;

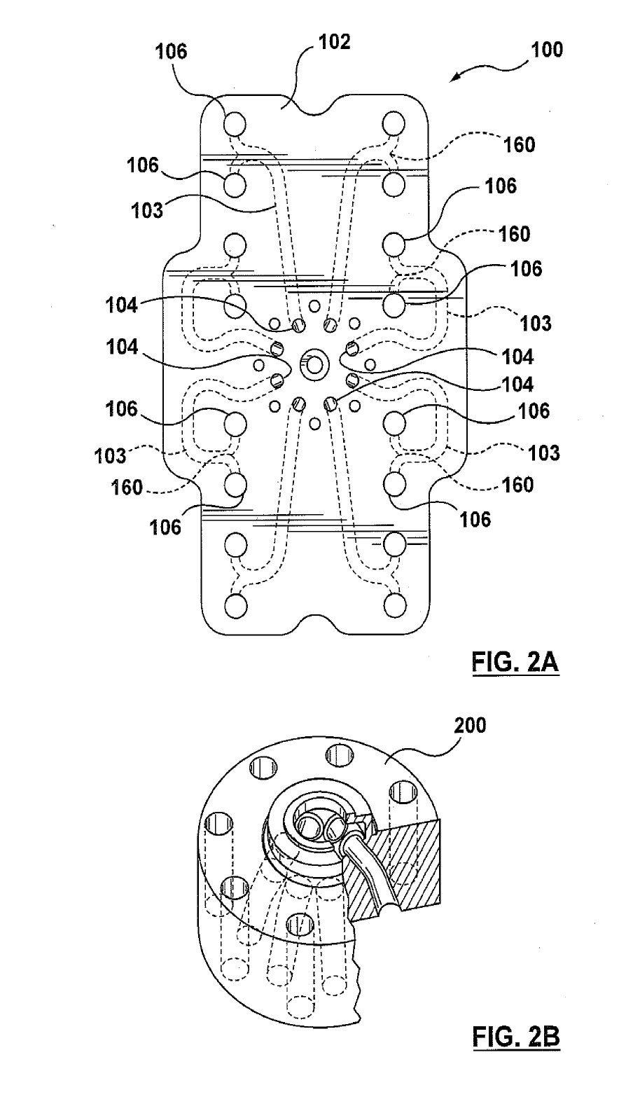

FIG. 2A is a schematic view of one embodiment of a mold-tool system with multiple inlets, each with multiple outlets;

FIG. 2B is a schematic view of a sprue-transition bushing;

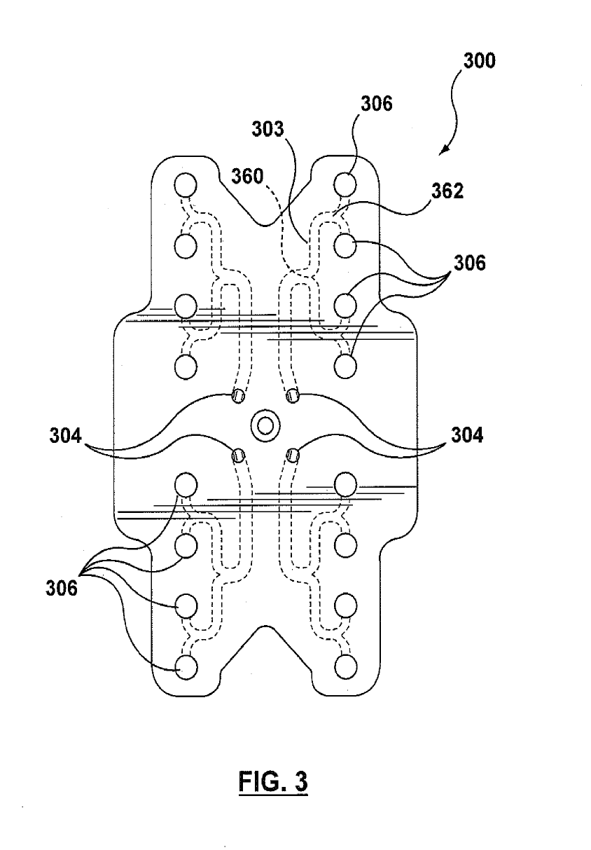

FIG. 3 is a schematic view of another embodiment of a mold-tool system;

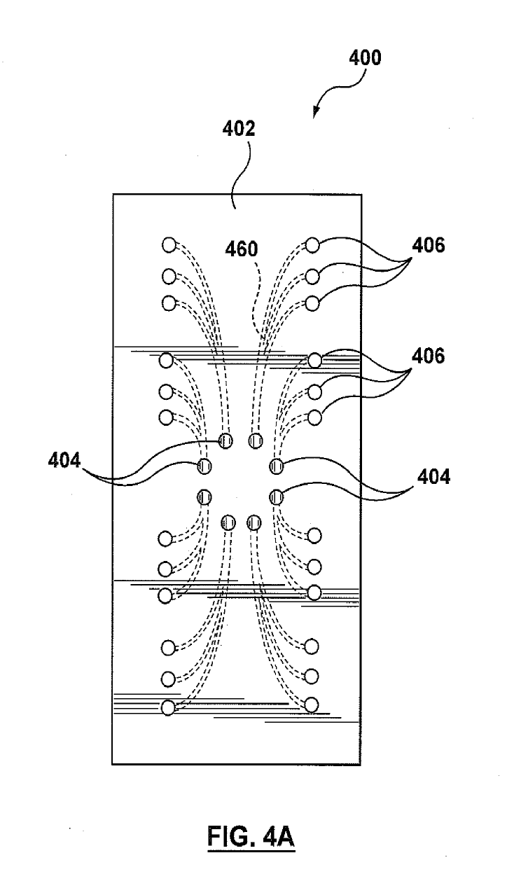

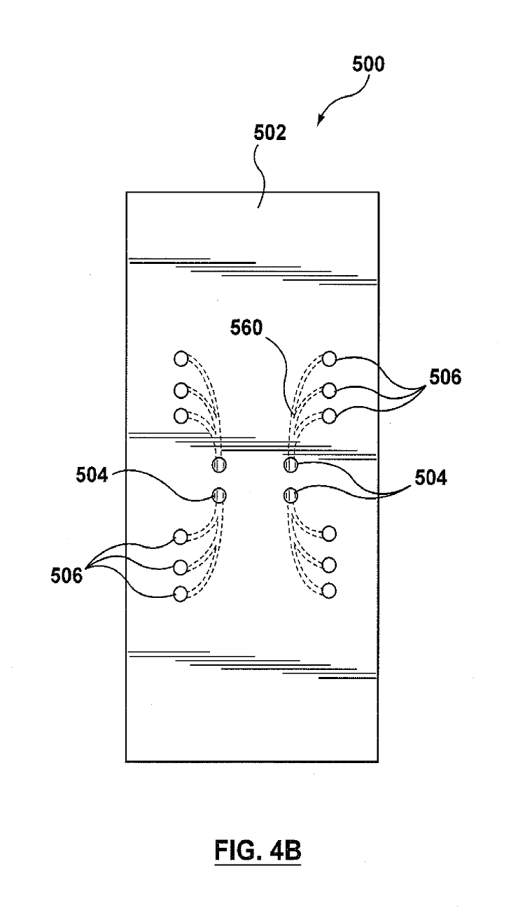

FIG. 4A is a schematic view of yet another embodiment of a mold-tool system; and

FIG. 4B is a schematic view of another embodiment of a mold-tool system.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2A, 2B are schematic representations of a mold-tool system (100). FIG. 1 is a perspective view of the mold-tool system (100). The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9).

The definition of the mold-tool system (100) is as follows: a system that may be positioned and/or used in an envelope defined by a platen system of the molding system, such as, for example, an injection-molding system. The platen system may include a stationary platen and a movable platen that is moveable relative to the stationary platen. The mold-tool system (100) may be used and/or built into (but is not limited to) the following assemblies/system: a runner system, such as a hot runner system or a cold runner system, and/or any sub-assembly or part thereof.

FIG. 2A, depicts an example of the mold-tool system (100) that may include a one-piece manifold assembly (102) having multiple inlets (104) and multiple outlets (106). The one-piece manifold assembly (102) may include a plurality of melt channels (103) that extend between associated ones of the multiple inlets (104) and outlets (106). The outlets (106) are spaced apart from the associated inlets (104). Each channel (103) connects an inlet (104) with at least two outlets (106). Each inlet (104) therefore, may be in fluid communication with at least two outlets (106). In one embodiment of the invention, each inlet (104) may be associated with: (i) two outlets, (ii) three outlets, (iii) four outlets, (iv) five outlets, and/or (v) six outlets, etc. For example, each inlet (104) may be assigned to: (i) a minimum of four outlets (106), (ii) a minimum of three outlets (106), and/or (iii) a minimum of two outlets (106). Other equivalent arrangements may be contemplated that fall within the scope of the invention.

As shown in FIG. 2A, in one embodiment, each of the melt channels (103) has a length that is substantially equal to a length of some, or all, of the other melt channels. Applicant has recognized that it may be desirable for the length of each of the melt channels to be substantially equal because this equal length allows the flow characteristics at each of the outlets (106) to be substantially similar.

As shown in the embodiment of FIG. 2A, each of the melt channels (103) includes a bifurcation (160) where the melt channel branches into at least a first branch and a second branch. As illustrated, the length of the first branch may be substantially identical to the length of the second branch.

In one embodiment, it may be desirable to position the bifurcation (160) closer to the outlets (106) than to the inlets (104). When the flow first passes through the inlets, the flow may be less symmetrical. As the flow passes along the length of the melt channel (103) towards the outlets (104), the flow may develop a substantially symmetrical flow pattern. Thus, in one embodiment, the bifurcation (160) is positioned downstream of the inlet, in a location where the flow pattern is substantially symmetrical. In one embodiment, the bifurcation (160) is positioned at a location in which the distance between the inlet (104) and the bifurcation (160) is at least 60% of the length of the melt channel (103). In another embodiment, the bifurcation (160) is positioned at a location in which the distance between the inlet (104) and the bifurcation (160) is at least 70% of the length of the melt channel (103). In yet another embodiment, the bifurcation (160) is positioned at a location in which the distance between the inlet (104) and the bifurcation (160) is at least 80% of the length of the melt channel (103), and in yet another embodiment, the bifurcation (160) is positioned at a location in which the distance between the inlet (104) and the bifurcation (160) is at least 90% of the length of the melt channel (103).

The outlets (106) may be arranged to feed mold cavities. In one embodiment, one outlet (106) is configured to feed a first cavity, whereas an adjacent associated outlet (106) is configured to feed a second cavity. Typically, each outlet (106) may be configured to feed a separate mold cavity. In another embodiment, one or more of the outlets (106) may be configured to feed the same mold cavity.

The manifold assembly (102) may be formed of a single body, and may be manufactured by using known 3D manufacturing methods. Examples of 3D manufacturing methods include direct digital manufacturing, sometimes called rapid, direct, instant, or on-demand manufacturing, and is a manufacturing process which creates physical parts directly from 3D CAD files or data using computer-controlled additive fabrication techniques without human intervention. This technique is also called 3D printing, or rapid prototyping. When a small low cost device is used, it may also called desktop or personal manufacturing. Additive freeform fabrication is solely intended to describe production of a 3D printed part that is to be used as the final product with minimal post-processing. Additive freeform fabrication is simply an alternative way of describing the 3D printing process itself. Additive manufacturing is also referred to as Additive Freeform Fabrication, Rapid Prototyping, Layered manufacturing or 3D printing. This technique physically constructs 3D geometries directly from 3D CAD files. Additive Manufacturing or Direct Digital Manufacturing is an extension of Rapid Prototyping to real parts for use as final products (not prototypes). A main technology used for additive manufacturing is Selective laser sintering, a process which uses laser energy to fuse material to create a solid object. Another technology is called Fused Deposition Modeling (FDM), which is commonly used for rapid prototyping, but is becoming more and more popular in direct digital manufacturing.

It is believed that the mold-tool system (100) of the present invention may reduce pressure drop, improve imbalance, and/or reduce the amount of shear heating in a molding resin. It is believed that the mold-tool system (100) may provide a geometrically evenly divided melt flow, into a homogeneous melt flow front. It is believed that the mold-tool system (100) may reduce an amount of A.A. (Acetaldehyde) levels that may be created for PET resin. Polyethylene terephthalate (PET), is a thermoplastic polymer resin of the polyester family and is used in synthetic fibers; beverage, food and other liquid containers; thermoforming applications; and engineering resins, often in combination with glass fiber. Acetaldehyde is a gas that is released from PET due to presence of moisture during the melting of PET in an injection molding process. Acetaldehyde gas may get trapped within the walls of preforms (articles molded from PET); Acetaldehyde may be slowly released once the preform is blow molded into a container (such as a bottle). Acetaldehyde may affect the taste and flavor of the some types of products packed in the container. Poorly designed and manufactured screws (used in a melt-preparation system), hot-runner systems and resin dryers may result in higher generation of A.A. levels. A poor manufacturing process may also result in higher A.A. levels. High A.A. levels may also result from use of high levels of regrind (recycled PET).

FIG. 2B depicts a sprue-transition bushing (200) that may communicate with inlets (104). For example, the one-piece manifold assembly (102) may have sixteen (16) drops (outlets) and may have eight (8) inlets that interface with the sprue-transition bushing (200). Each inlet (104) may feed resin to a melt channel (103) in the one-piece manifold assembly (102), and the melt channel (103) may split somewhere between the inlet and the respective outlets. The mold-tool system (100) may reduce the number of times the resin is split in the manifold assembly (102), which leads to an improvement in balance because resin splits in the melt channel (103) may be one of the main causes of imbalance in a hot-runner system.

FIG. 3 is a schematic representation of another example of the mold-tool system (300). In the embodiment illustrated in FIG. 3, the mold-tool system (300) has a ratio of one inlet (304) to four outlets (306). Each inlet (304) is in fluid communication with a respective set of outlets (or grouping of outlets) (306). There are a total of four (4) inlets (304), and a total of sixteen (16) outlets (306).

In this embodiment illustrated in FIG. 3, each melt channel (303) includes a first bifurcation (360) and a second bifurcation (362). In one embodiment, both the first bifurcation (360) and the second bifurcation (362) are positioned at a location in which the distance between the inlet (104) and each bifurcation (360, 362) is at least 60% of the length of the melt channel (303). In another embodiment, both the first bifurcation (360) and the second bifurcation (362) are positioned at a location in which the distance between the inlet (304) and each bifurcation (360, 362) is at least 70% of the length of the melt channel (303). In yet another embodiment, both the first bifurcation (360) and the second bifurcation (362) are positioned at a location in which the distance between the inlet (304) and each bifurcation (360, 362) is at least 80% of the length of the melt channel (303), and in yet another embodiment, both the first bifurcation (360) and the second bifurcation (362) are positioned at a location in which the distance between the inlet (304) and each bifurcation (360, 362) is at least 90% of the length of the melt channel (303).

FIG. 4A is a schematic representation of another example of the mold-tool system (400). According to the example depicted in FIG. 4A, the mold-tool system (400) has a ratio of one inlet (404) to three outlets (406). Each inlet (404) is in fluid communication with a respective set or grouping of the outlets (406). That is, there are a total of eight (8) inlets (404), and a total of twenty four (24) outlets (406).

FIG. 4B is a schematic representation of another example of the mold-tool system (500). According to the example depicted in FIG. 4B, the mold-tool system (500) has a ratio of one inlet (504) to three outlets (506). Each inlet (504) is in fluid communication with a respective set or grouping of the outlets (506). That is, there are a total of four (4) inlets (504), and a total of twelve (12) outlets (506). It will be appreciated that another example may be arranged such that (without limitation) there is a ratio of one inlet (504) to two outlets (506).

As illustrated, in the particular embodiments shown in FIGS. 4A-4B, the bifurcations (460 and 560) are positioned closer to the inlets (504) than to the outlets (506). This is in contrast to the embodiments illustrated in FIGS. 2A and 3, where the bifurcations (160, 360, 362) are positioned closer to the outlets (506) than to the inlets (504).

It will be appreciated that the assemblies and modules described above may be connected with each other as may be required to perform the desired functions and tasks that are within the scope of persons of skill in the art without having to describe each and every one of them in explicit terms. There is no particular assembly, components, or software code that is superior to any available to the art. There is no particular mode of practicing the inventions and/or examples of the invention that are superior to others, so long as the functions may be performed.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system, comprising:
a manifold assembly comprising:
a plurality of inlets; and
a plurality of outlets spaced apart from the plurality of inlets;
a plurality of melt channels extending between the plurality of inlets and the plurality of outlets, wherein each melt channel extends between a single inlet and at least two outlets such that each inlet is in fluid communication with at least two outlets.

2. The mold-tool system of claim 1, wherein:
each inlet is in fluid communication with four outlets.

3. The mold-tool system of claim 1, wherein:
there is a ratio of one inlet to four outlets, and
each inlet is in fluid communication with a respective set of outlets.

4. The mold-tool system of claim 3, wherein there are a total of four inlets, and a total of sixteen outlets.

5. The mold-tool system of claim 1, wherein:
there is a ratio of one inlet to three outlets.

6. The mold-tool system of claim 5, wherein:
each of the inlets is in fluid communication with a respective set of outlets, and
there are a total of eight inlets, and a total of twenty four outlets.

7. The mold-tool system of claim 1, wherein:
each of the inlets is in fluid communication with a respective set of outlets, and
there are a total of four inlets, and a total of twelve outlets.

8. The mold-tool system of claim 1, wherein:
there is a ratio of one inlets to two outlets.

9. The mold-tool system of claim 1, wherein:
there is a ratio of one inlet to a minimum of four outlets.

10. The mold-tool system of claim 1, wherein:
there is a ratio of one inlet to a minimum of three outlets.

11. The mold-tool system of claim 1, wherein:
there is a ratio of one inlet to a minimum of two outlets.

12. The mold-tool system of claim 1, further comprising a bushing that interfaces with each of the inlets.

13. The mold-tool system of claim 1, wherein each of the melt channels has a length that is substantially identical to a length of another melt channel.

14. The mold-tool system of claim 1, wherein each of the melt channels includes a bifurcation where the melt channel branches into at least a first branch and a second branch, wherein the length of the first branch is substantially identical to the length of the second branch.

15. The mold-tool system of claim 1, wherein each of the melt channels includes a bifurcation where the melt channel branches into at least a first branch and a second branch, wherein the bifurcation is positioned closer to the plurality of outlets than the plurality of inlets.

16. The mold-tool system of claim 15, wherein each of the melt channels is bifurcated into a first melt channel and a second melt channel, wherein the first melt channel has a first length and the second melt channel has a second length, wherein the first length is substantially equal to the second length.

17. The mold-tool system of claim 16, wherein the bifurcation is positioned at a location in which a distance between the inlet and the bifurcation is at least 70% of a length of the first melt channel.

18. The mold-tool system of claim 16, wherein the bifurcation is positioned at a location in which a distance between the inlet and the bifurcation is at least 80% of a length of the first melt channel.

19. The mold-tool system of claim 16, wherein the bifurcation is positioned at a location in which a distance between the inlet and the bifurcation is at least 90% of a length of the first melt channel.

20. A one-piece manifold assembly for a mold-tool system, comprising:
a plurality of inlets;
a plurality of outlets, wherein the ratio of outlets to inlets is at least 2:1;
a plurality of melt channels, wherein each melt channel extends between a single inlet and at least two outlets, each outlet being connected to the melt channel by an associated melt channel section, such that each inlet is in fluid communication with at least a first melt channel section associated with one outlet, and a second melt channel selection associated with another outlet, wherein the first melt channel section has a first length and the second melt channel section has a second length, wherein the first length is substantially equal to the second length.

21. The one-piece manifold assembly of claim 20, further comprising a bifurcation where the first melt channel section associated with one outlet and the second melt channel associated with another outlet diverge, wherein the bifurcation is positioned at a location in which a distance between the inlet and the bifurcation is at least 60% of a length of the melt channel.

22. The one-piece manifold assembly of claim 21, wherein the bifurcation is positioned at a location in which a distance between the inlet and the bifurcation is at least 70% of a length of the melt channel.

23. The one-piece manifold assembly of claim 21, wherein the bifurcation is positioned at a location in which a distance between the inlet and the bifurcation is at least 80% of a length of the melt channel.

24. The one-piece manifold assembly of claim 21, wherein the bifurcation is positioned at a location in which a distance between the inlet and the bifurcation is at least 90% of a length of the melt channel.
